(19) United States
(12) Patent Application Publication
(10) Pub. No.: US 2010/0111631 A1
(43) Pub. Date: May 6, 2010

(54) Tool for Finishing the Ends of Surgical Rods and Methods of Use

(75) Inventors: Hai H. Trieu, Cordova, TN (US); Jeff R. Justis, Germantown, TN (US)

Correspondence Address: MEDTRONIC;Attn: Noreen Johnson - IP Legal Department, 2600 Sofamor Danek Drive, MEMPHIS, TN, 38132, US

(73) Assignee: WARSAW ORTHOPEDIC, INC., Warsaw, IN (US)

(21) Appl. No.: 12/262,760

(22) Filed: Oct. 31, 2008

(51) Int. Cl. B23C 1/20

(52) U.S. Cl. 409/179

(57) ABSTRACT

An apparatus for finishing an end of a rod including a shaping tool comprising a shaping assembly having a shaping housing and a shaping surface within the housing configured to engage an end of a rod and form a shaped rod end. The apparatus further including a finishing tool comprising a finishing assembly having a finishing surface for changing the contour of the shaped rod end to form a finished rod end.

### BACKGROUND

1. Field of the Disclosure

The following is directed to surgical tools, and particularly a surgical tool for finishing the ends of a surgical rods.

2. Description of the Related Art

In human anatomy, the spine is a generally flexible column that can take tensile and compressive loads. The spine also allows bending motion and provides a place of attachment for tendons, muscles and ligaments. Generally, the spine is divided into four sections: the cervical spine, the thoracic or dorsal spine, the lumbar spine, and the pelvic spine. The pelvic spine generally includes the sacrum and the coccyx. The sections of the spine are made up of individual bones called vertebrae. Also, the vertebrae are separated by intervertebral discs, which are situated between adjacent vertebrae.

There are a variety of different spinal abnormalities, including for example, improper curvatures, deformed vertebrae, misaligned vertebrae, which may be cured or mitigated by implantation of certain devices. Such devices can include articles and mechanisms useful for repairing damaged portions of the spine, stabilizing portions of the spine, or even changing the position of the spine to a more natural state. In certain instances, rods can be employed to stabilize or correct an abnormal portion of the spine.

The rods can be implanted in a variety of ways, including percutaneous delivery, a less invasive surgical option wherein small punctures are formed in the patient as opposed to a single, large opening. However, use of rods typically includes cutting the rod to a desirable length based on the implant design and the implants intended use. Cutting of the rod can be done using a table-top cutter, however, given the rigidity of surgical rod materials and the act of cutting, such rods can be left with burrs, sharp edges, and other irregularities at the cut end. Such surface irregularities can lead to tissue irritation, damage to collateral structures upon implantation thus increasing the risk of infection, and other problems.

Because of the regular use of rods, and the need to cut such rods during many different surgical procedures, the industry continues to demand improvements in such implants and methods of using such articles

### SUMMARY

According to one aspect, an apparatus for finishing an end of a rod includes a shaping tool comprising a shaping assembly having a shaping housing and a shaping surface within the housing configured to engage an end of a rod and form a shaped rod end. The apparatus further includes a finishing tool including a finishing assembly comprising a finishing surface for changing the contour of the shaped rod end to form a finished rod end.

In another aspect, an apparatus for finishing an end of a rod including a shaping tool comprising a shaping assembly including a shaping housing and a shaping surface within the shaping housing, the shaping surface configured to engage and shape an end of a rod to form a shaped rod end. The apparatus further includes a finishing tool comprising a finishing assembly including a broaching assembly configured to remove material and change a contour of the shaped rod end to form a finished rod end.

According to another aspect, an apparatus for finishing an end of a rod includes a cutting tool comprising a cutting assembly configured to sever a rod, and a shaping tool comprising a shaping assembly including a housing and a shaping surface within the housing, wherein the shaping surface is configured to remove material from an end of the rod and form a shaped rod end. The apparatus further includes a finishing tool comprising a finishing assembly including a broaching assembly for changing a contour of the shaped rod end to form a finished rod end.

According to another aspect, a method of finishing an end of a surgical rod is disclosed that includes the steps of cutting a surgical rod to be implanted to form a surgical rod having a cut rod end and shaping the cut rod end by changing the contour of the cut rod end and forming a shaped rod end. The process further includes finishing the surgical rod by changing the contour of the shaped rod end to form a finished rod end.

### BRIEF DESCRIPTION OF THE DRAWINGS

FIG. 1 includes a lateral view of a portion of vertebral column.

FIG. 2 includes a top plan view of a vertebra.

FIG. 3 includes a flow chart for a process of finishing an end of a surgical rod in accordance with an embodiment.

FIG. 4 includes a perspective view of a tool including a shaping assembly and a finishing assembly in accordance with an embodiment.

FIG. 5 includes a perspective view of a portion of a shaping assembly in accordance with an embodiment.

FIG. 6 includes a perspective view of a portion of a finishing assembly in accordance with an embodiment.

FIGS. 7A through 7F include cross-sectional illustrations of different contours of finished rod ends formed using devices and methods in accordance with embodiments.

FIGS. 8A and 8B include side view illustrations of alternative rods that can be formed to have different end contours using the devices and methods in accordance with embodiments.

FIGS. 9A and 9B include illustrations of portions of a spine incorporating rod and anchor systems, wherein the rod ends are contoured using the devices and methods in accordance with embodiments.

### DETAILED DESCRIPTION

### Description of Relevant Anatomy

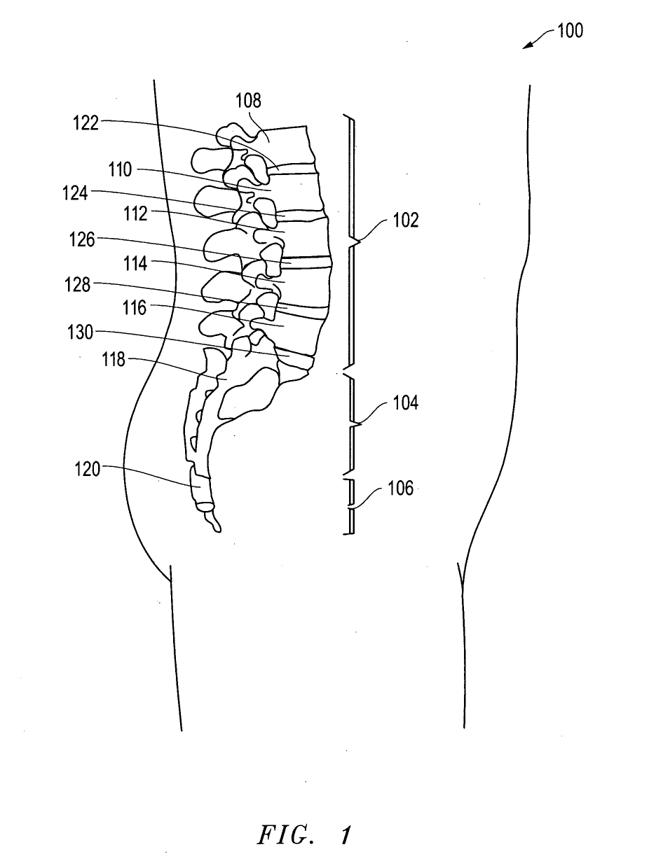

Referring initially to FIG. 1, a portion of a vertebral column, designated 100, is shown. As depicted, the vertebral column 100 includes a lumbar region 102, a sacral region 104, and a coccygeal region 106. The vertebral column 100 also includes a cervical region and a thoracic region. For clarity and ease of discussion, the cervical region and the thoracic region are not illustrated.

As illustrated in FIG. 1, the lumbar region 102 includes a first lumbar vertebra 108, a second lumbar vertebra 110, a third lumbar vertebra 112, a fourth lumbar vertebra 114, and a fifth lumbar vertebra 116. The sacral region 104 includes a sacrum 118. Further, the coccygeal region 106 includes a coccyx 120.

As depicted in FIG. 1, a first intervertebral lumbar disc 122 is disposed between the first lumbar vertebra 108 and the second lumbar vertebra 110. A second intervertebral lumbar disc 124 is disposed between the second lumbar vertebra 110 and the third lumbar vertebra 112. A third intervertebral lumbar disc 126 is disposed between the third lumbar vertebra 112 and the fourth lumbar vertebra 114. Further, a fourth intervertebral lumbar disc 128 is disposed between the fourth lumbar vertebra 114 and the fifth lumbar vertebra 116. Additionally, a fifth intervertebral lumbar disc 130 is disposed between the fifth lumbar vertebra 116 and the sacrum 118.

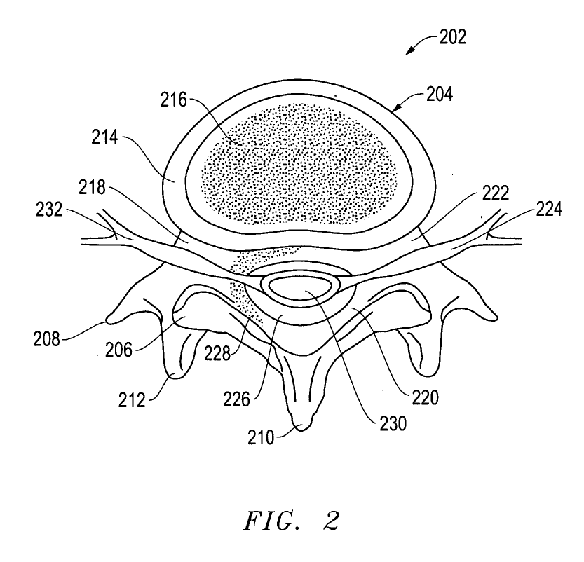

Referring to FIG. 2, a vertebra 202 is illustrated. As shown, the vertebral body 204 includes a cortical rim 214 composed of cortical bone. Also, the vertebral body 204 includes cancellous bone 216 within the cortical rim 214. The cortical rim 214 is often referred to as the apophyseal rim or apophyseal ring. Further, the cancellous bone 216 is generally softer than the cortical bone of the cortical rim 214.

As illustrated in FIG. 2, the vertebra 202 further includes a first pedicle 222, a second pedicle 218, a first lamina 220, and a second lamina 228. Further, a vertebral foramen 226 is established within the vertebra 202. A spinal cord 230 passes through the vertebral foramen 226. Moreover, a first nerve root 224 and a second nerve root 232 extend from the spinal cord 230. Notably, during implantation of anchors, such as screws within the spine, particularly anchors that will be attached to other implants, such as a rod, such screws can generally be implanted within the pedicles 218 and 222, since these portions of the spine provide suitable support and rigidity for anchors.

The vertebrae that make up the vertebral column have slightly different appearances as they range from the cervical region to the lumbar region of the vertebral column. However, all of the vertebrae, except the first and second cervical vertebrae, have the same basic structures.

### Description of Embodiments

Oftentimes, during a surgical procedure, a rod must be installed within a patient for stabilization or correction of a spinal abnormality. It is commonplace for a surgeon to make measurements and cut rods to the proper length during a surgical procedure such that the implant is properly configured to work with the particular patient. However, rod cutting is a labor-intensive procedure since the rod materials are particularly hard, and the cutting procedure can result in rod ends having burrs, sharp corners, or other irregularities that can cause irritation or collateral damage to surrounding tissue upon implanting. Accordingly, such rods can be difficult to implant, especially via percutaneous delivery methods. The following embodiments are directed to a process of finishing rod ends as well as tools and assemblies useful for forming such finished rod ends.

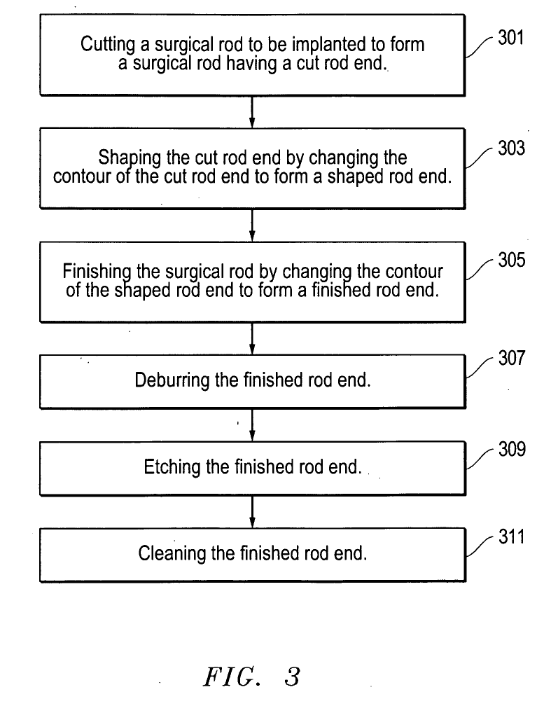

FIG. 3 includes a flowchart providing a process for finishing the end of a surgical rod in accordance with an embodiment. As illustrated, the process starts at step 301 by cutting a surgical rod to be implanted to form a surgical rod having a cut rod end. Such a cutting process can include measuring the proper length of rod and severing the rod, leaving the surgeon with the desired rod length.

In reference to certain characteristics of surgical rods, generally such rods are solid cylindrical shapes providing rigid support for correction of spinal abnormalities. Surgical rods can come in a variety of diameters to treat different disorders, but typically the rods have an average diameter of at least about 2 mm, and particularly, within a range between about 3 mm and 10 mm.

Some surgical rods can be made from metal or metal alloys. Suitable metal materials can include metals such as titanium, aluminum, vanadium, chromium, cobalt, molybdenum, nickel, copper, iron, manganese, tantalum, tungsten, and any combination thereof. It will be appreciated that such metal rods are selected based upon their stiffness and strength, which may make cutting such rods troublesome, and likely to leave the cut rod end with irregularities.

In addition to metal and metal alloys rods, some surgical rods may also be made of polymer materials. Some such suitable polymer materials, include polyurethanes, polyolefins, polyethers, polyesters, and polycarbonates. In accordance, with a particular embodiment, surgical rods may be polyether materials including, for example, polyetherketone (PEK), polyetheretherketone (PEEK), polyetherketoneketone (PEKK), or polyaryletherketone (PAEK). Surgical rods made of such polymer materials may be selected in certain instances where the surgeon wishes to stabilize the spine with a less rigid implant architecture. However, such materials still pose the same difficulties in cutting, namely resulting in severed rod ends having burrs and irregularities.

In addition, the surgical rods can be composite materials that can include a combination of materials such as metals, ceramics, and polymers. In particular instances, the rods can be composite materials that include another phase of material or a completely different material contained therein as a reinforcing material. The reinforcing materials can include ceramic, polymer, or metal materials, depending upon the combination of materials. For example, the composite rod can include a metal material having a polymer insert contained therein (e.g., PEEK rod with metal sleeve). Alternatively, the composite rod can include a polymer material having a reinforcing insert made of metal or ceramic (e.g., metal or ceramic rod with a PEEK sleeve). In certain exemplary cases, the reinforcing material may be present within the primary matrix material of the rod in the form of platelets, grains, fibers, or the like. Suitable ceramic materials can include carbon-containing materials (e.g., graphite, carbon fibers, carbon-nanotubes), oxides, nitrides, carbides, borides or any combination thereof. In certain instances, Such reinforcing materials may further complicate the cutting procedure leaving the rod end more likely to have notable irregularities.

After cutting the surgical rod to the desired length at step 301 the process can continue at step 303 by shaping the rod end by changing the contour of the cut rod end to form a shaped rod end. Shaping of the rod end is suitable for changing the contour of the rod end to a more suitable form in preparation for a finishing procedure. In accordance with one embodiment, the shaping process can include application of mechanical forces to the end of the rod, such that the contours of the rod end are changed. In other embodiments, depending upon the material of the rod, the shaping process can include the application of heat or chemicals to aid changing the contour of the rod end. For example, the shaping process can include forming processes such as abrading, cutting, swedging, pressing, etching, molding, heating, and any combination thereof. Notably, processes such as abrading, cutting, and etching can include removal of the material from the end of the rod. In certain other processes such as swedging, pressing, molding, and heating the rod material may not necessarily be removed from the edge of the rod, rather such processes may reform the existing rod end material into a new shape through application of mechanical force or a combination of mechanical force, thermal energy, and chemicals.

With reference to the shaping process in general, the shaping process can utilizing a shaping tool including a shaping assembly having an opening configured to receive an end of the rod. The shaping assembly can further include a shaping surface contained within the shaping housing configured to engage and shape the rod end. In certain embodiments, the shaping surface can be moved relative to the end of the rod, or the rod may be moved relative to the shaping surface, or even both the rod and the shaping surface can be moved relative to each other to complete the shaping process.

For example, in the context of an abrading shaping process, the shaping surface can include an abrasive material that removes material from the end of the rod, such as through a grinding process. The shaping surface can include abrasive materials such as ceramics, abrasive grains, metals, polymers or a combination thereof. Some suitable ceramic materials can include oxides, carbides, borides, nitrides, carbon-containing materials, and any combination thereof. It will be appreciated that the abrasive materials can include grains of abrasive materials or superabrasive materials, for example diamond, alumina, cubic boron nitride, a combination thereof, and the like.

The shaping surface can be moved relative to end of the rod such that the end of the rod is abraded to a desired contour. Movement of the shaping surface relative to the rod can include rotary motion of one or more shaping surfaces around a longitudinal axis of the surgical rod to abrade the cut end of the surgical rod, thereby removing material and contouring the rod end. Alternatively, the shaping surface may be stationary with respect to the rod and the rod may be rotated about its longitudinal axis while in contact with the abrasive shaping surface to complete the abrading process. In other embodiments, both the shaping surface containing and the surgical rod may be moved relative to each other to complete the shaping process. In certain instances, movement may include translational motion parallel, perpendicular, or tangential to the longitudinal axis of the rod. In more particular embodiments, the shaping process may make use of movement in multiple directions, for example coupling rotational motion with some translational motion.

According to another embodiment, the shaping process can include a cutting process in which material is removed from the end of the rod using a shaping surface having sharpened cutting surfaces. In accordance with an embodiment, such sharpened cutting surfaces can include ceramic materials, metal materials, or a combination thereof. Suitable ceramic materials can include oxides, borides, nitrides, carbides, other carbon-containing materials, such as diamond, or a combination thereof. Some suitable metal materials for use in the sharpened cutting surfaces can include titanium, tantalum, tungsten, vanadium, chrome, cobalt, iron, and any combination thereof.

As discussed with reference to the abrading process, the cutting process can include movement of the shaping surface relative to the rod, or movement of the rod relative to the shaping surface, or a combination of movement of the shaping surface and rod relative to each other. Such movement may include rotary motion such that the rod or the shaping surface is rotated about the longitudinal axis of the surgical rod. Additionally, a shaping process including cutting can further include translating the rod or shaping surface relative to each other in a direction parallel, perpendicular, or tangential to the longitudinal axis of the surgical rod.

In processes such as abrading and cutting the shaping process can further include the application of the liquid to the end of the rod. Application of a liquid facilitates cooling, swarf removal, and cleaning of the rod end during the process. Such liquids can include aqueous-based liquids, but may also include additives such as surfactants or grinding aids to aid the shaping process.

As will also be appreciated and described in more detail herein, the shaping process can be a manual or automatic process, for example, the motion of the shaping surface may be manually operated, such as by a surgeon or surgical aid. In other embodiments, motion of the shaping surface or rod can be controlled by a motor, which may be electrical or pneumatic.

According to another embodiment, the shaping process can include a swedging process. Generally, swedging includes pinching the end of the rod, such as between two or more shaping surfaces to change the contour of the end of the rod. Swedging is distinct from a pressing operation in that the shaping surfaces are generally small and the final rod contour is that of a crimped rod. Such a process may be suitable on softer rod materials, such as pure metal materials, like titanium, or more particularly, polymer containing materials, like PEEK. Additionally, it will be appreciated that a swedging process can be used to form particular surface features in the end of the rod, such as grooves or indentations. Still, swedging processes may be limited to small contour changes, and more particularly may be coupled with another shaping process, such as cutting.

Alternatively, the shaping process can also include a pressing process to change the contour of the end of the rod. Pressing operations are particularly suited for soft rod materials such as pure metallic materials like titanium, or alternatively, certain polymer materials such as PEEK. Additionally, a shaping process using pressing can include the application of heat to first soften or lower the stiffness of the rod material for easier pressing. After or during the application of heat, a shaping surface having the desired contour of the shaped rod end can engage and change the contour of the rod end through applied pressure. In the context of pressing, the shaped surface can be applied to the end of the rod under significant pressure to mechanically force the end of the rod to configure to the pressing surface.

Alternatively, the shaping process operation can use a molding operation. Like a pressing operation, the molding operation may use the application of heat, directed locally to the end of the rod to be shaped. Certain molding processes may use a chemical to soften the end of the rod and make it more pliable for molding. For example, certain corrosive chemicals may be suitable for softening the end of the rod. As such, the molding process can include shaping surfaces, otherwise molding surface, that have a desirable contour to form a shaped rod end having the same desired contour. Upon proper application of heat, pressure, and/or chemical components the molding surfaces can engage the end of the rod and mold the rod end to change the contour of the end of the rod.

It will be appreciated that the application of heat, pressure, or chemicals can be used in other shaping processes, including abrading and cutting processes. Moreover, the shaping process can utilize a liquid which may be suitable for cooling, swarf removal, and cleaning of the rod end during processing. Such liquids can include additives such as a surfactant or grinding aids depending upon the finishing process.

The shaping process, can use a selection of a shaping heads as part of the shaping assembly such that each of the shaping heads are interchangeable with a portion of the shaping assembly. Each of the shaping heads can have a different finishing surface such that each shaping head is capable of providing a different shaped rod end contour. As such, the surgeon can select a desired shaping contour by selecting the proper interchangeable shaping head.

Moreover, in certain embodiments, the shaping process can include use of a series of interchangeable shaping heads in a particular order to impart a desired shaped rod end contour. For example, if a surgeon desires a rounded end, it may be desirable to use more than one interchangeable shaping head, wherein a first shaping head is used to chamfer the corners of the rod end, and a second shaping head is interchanged with the first, wherein the second shaping head further changes the contour of the rod end, such as imparting a rounded, semi-hemispherical contour.

After shaping the cut rod end at step 303 the process continues at step 305 by finishing the surgical rod. The finishing process includes a process for further changing the contour of the rod end, and can involve substantial changes to the rod end contours to form a finished rod end. For example, the finishing process can include modifications to the shaped rod end such as provision of surface features like grooves, precision curved surfaces, chamfers, flats, indentations, or a combination of such features for improving the coupling capabilities of the rod end and even providing a suitable finished shape for percutaneous delivery of the rod. According to one particular embodiment, the combination of the shaping and finishing processes entails an initial rough shaping process, coarse in scale and significantly altering the rod end contour, followed by a precision finishing process to form particular surface features, modifying the overall contour of the rod to a lesser degree than the shaping process, yet capable of significant alterations in the form of certain surface features.

Some such suitable finishing processes can include abrading, cutting, swedging, broaching, etching, pressing, molding, and heating, and any combination thereof. Still, according to one particular embodiment, the finishing process can include a different forming process than that of the shaping process. Finishing of the rod end can include the insertion of the shaped rod end within a finishing assembly which may include finishing surfaces suitable for carrying out one of the above identified processes. Processes such as abrading and cutting can include processes similar to those described in accordance with shaping. Other processes such as swedging, pressing, etching, molding and heating can include those processes previously described in accordance with shaping.

Moreover, the finishing process can include movement of the surgical rod relative to a finishing surface, or movement of the finishing surface relative to the rod, or movement of both the finishing surface and the rod relative to each other. As described above, such motion can include rotary motion, typically around a longitudinal axis of the rod, but may further includes translational motion in a direction parallel, perpendicular, or tangential (i.e., not perpendicular) to the longitudinal axis of the rod.

According to one particular embodiment, the finishing process includes a broaching process. Broaching is generally the application of a mechanical force to the end of the rod by a series of broaching teeth, each of which is designed to remove a small portion of material from the shaped rod end to form a finished rod end. In accordance with a particular embodiment, use of a broaching process as the finishing process can include translation of a broaching assembly relative to the surgical rod. Such translation can be in a direction substantially perpendicular to the longitudinal axis of the rod, including either horizontally or vertically with respect to a major plane of the tool. In one embodiment, the broaching process can include ratcheted motion control, wherein the translation of the broaching assembly is carried out using a geared surface engaged with a complementary toothed surface to avoid back-tracking (i.e., reversing in direction) of the broach assembly relative to the rod to assure a precision finish. Further description of this will be provided in accompanying embodiments herein.

The finishing process can utilize a liquid which may be suitable for cooling, swarf removal, and cleaning of the rod end during processing. Such liquid can include additives such as a surfactant or grinding aids depending upon the finishing process.

The finishing process can include a selection of a finishing heads from a plurality of interchangeable finishing heads. Each of the finishing heads has a different finishing surface such that each head is capable of providing a different finished rod end contour. As such, the surgeon can select the contour of the finished rod end, by selecting the proper interchangeable finishing head. Also, the finishing heads are interchangeable, such that the finishing assembly is designed to releasably couple with any one of the interchangeable finishing heads. Alternatively, such finishing heads, particularly in the context broaching assemblies, may be part of an interchangeable insert as described in more detail herein.

After forming the finished rod end at step 305, the process can continue at step 307 with an optional deburring process. The deburring process can include removal of sharp corners, burrs, or irregularities from the finished rod end. Such a deburring process can include the application of an abrasive material, which can be moved relative to the surface of the finished rod end, to grind or polish away the irregularities. In accordance with one embodiment, the deburring process can include moving the rod over an abrasive pad containing abrasive materials, for example sand paper. In accordance with another embodiment, the deburring process can include the engagement of the finished rod end with a rotating abrasive wheel designed to abrade the finished rod end and remove sharp surfaces. Such abrasive wheels can include abrasive flaps, abrasive pads, abrasive discs, abrasive cones, or the like. It will be appreciated that the deburring process can be a manual process, an automated process, or a combination thereof.

The process may further include an optional etching process at step 309. In particular, the etching process can include etching the finished rod end to provide a texture to certain portions of the finished rod end. Texturing of the finished rod end can be suitable for providing a gripping surface for improved coupling of the rod end with another implanted component. In accordance with an embodiment, the etching process can be undertaken by using a chemical etchant or, alternatively, an electromagnetic beam, such as a laser.

The process may further include an optional cleaning process at step 311. The cleaning process can include cleaning the finished rod end to remove potential contaminants which may be harmful in the context of surgical procedures. Such a cleaning process may include the use of aqueous-based liquids, such as de-ionized water, to remove particles and swarf from the shaping and finishing processes. Alternatively, the cleaning process may further include use of anti-bacterial and/or anti-microbial cleaning components to ensure sterilization of the end of the rod. Additionally, the cleaning process may further include the application of heat to the finished rod end.

Additionally, the process can include an optional capping process in which the finished end of the rod can be further treated. In certain embodiments, the capping process can include the selection and placement of a preformed end cap on the contoured rod end. Such an end cap may be suitable for maintaining a clean rod end and provide additional contour features that may not necessarily been machined into the rod end. For example, in one embodiment, the end cap can include surface features suitable for engaging, affixing, or locking the end of the rod with another implanted member. Some such suitable surface features can include grooves, openings, protrusions, depressions and the like. In one particular embodiment, the end cap can include a moveable member, such as a fastener, a hinge, or other mechanism suitable for placement and engaging the end of the rod relative to another implanted member. In such embodiments using a moveable mechanism within the end cap, mechanical members such as biasing members and the like may be used in conjunction with the moveable member to bias the moveable member into a closed position to retain a portion of the implant within the end cap.

The end cap can be made of materials such as metal, ceramic, polymer, or a combination thereof. The metals can include pure metal materials or metal alloys, Suitable metal materials can include metals such as titanium, aluminum, vanadium, chromium, cobalt, molybdenum, nickel, copper, iron, manganese, tantalum, tungsten, and any combination thereof. Some suitable ceramic materials can include carbon-containing materials (e.g., graphite, carbon fibers, or carbon nanotubes), oxides, borides, nitrides, carbides, and a combination thereof. Some such suitable polymer materials, include polyurethanes, polyolefins, polyethers, polyesters, and polycarbonates. In accordance, with a particular embodiment, surgical rods may be polyether materials including, for example, polyetherketone (PEK), polyetheretherketone (PEEK), polyetherketoneketone (PEKK), or polyaryletherketone (PAEK). As will be appreciated, any one of the above noted materials can be used in combination with any of the other materials, and such combinations can include the use of such materials as reinforcing materials.

According to another embodiment, the capping process may not necessarily utilize placement of a preformed end cap, and instead, may include the formation of a suitable end cap. Such a process can include the formation of an end cap over the finished end of the rod. Suitable forming processes can include molding, pressing, and the like. In one exemplary embodiment, the end cap is formed in-situ during a surgical procedure via a molding process. Such a molding process may be particularly suitable for end caps made of polymer materials, like PEEK. In certain instances the molding process can include an injection molding process. Other processes may utilize application of heat during the forming process, for instance, in the case of a hot pressing or hot molding process. The application of heat may be particularly suitable in the context of forming an end cap of a polymer material.

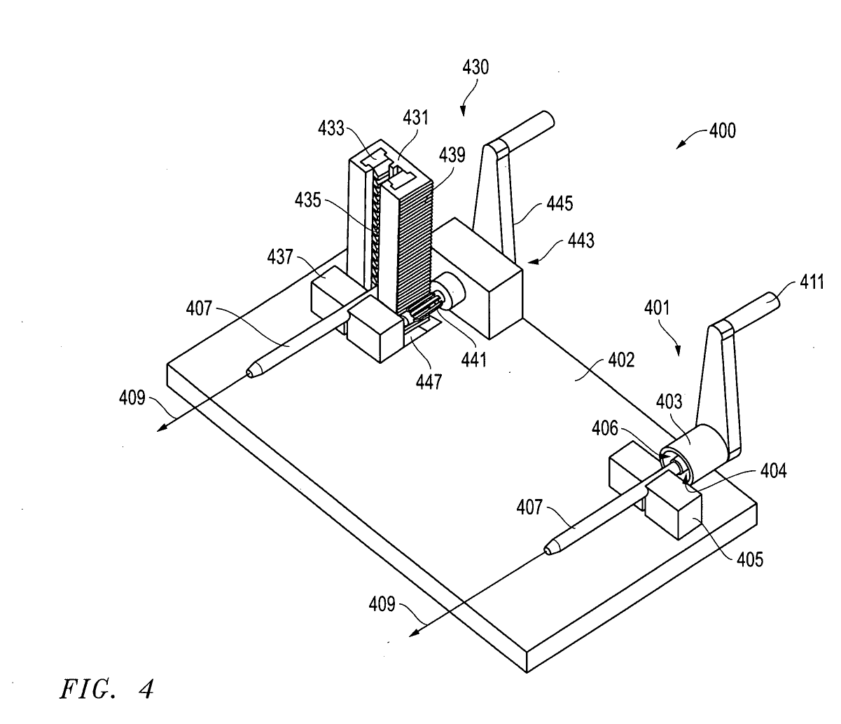

FIG. 4 includes a perspective view of a tool for finishing a rod end in accordance with an embodiment. In particular, the tool 400 is a table-top tool including a shaping assembly 401 attached to a major planar surface 402 of the tool 400 and a finishing assembly 430 attached to the same major planar surface 402 of the tool 400. As will be appreciated, the tool 400 is a small (i.e., non-industrial sized) tool suitable for use in an operatory. Moreover, as will appreciated, the table-top tool 400 including all of its components are made of materials suitable for sterilization, such as via autoclaving.

The tool 400 includes a shaping assembly 401 attached to the major planar surface 402. In accordance with a particular embodiment, the shaping assembly 401 includes a shaping housing including a shaping head 403 having an opening 406 configured to receive an end of a surgical rod 407 for shaping within the interior by a shaping surface 404. In certain instances the shaping assembly 401 can include a vise 405 useful for holding the surgical rod 407 in place relative to the shaping assembly 401. As illustrated, the shaping assembly may include a shaping head 403 coupled to a handle 411 for operation by a surgeon. As such, the end of the surgical rod 407 can be inserted into the opening 406 of the shaping assembly 401 and the shaping assembly 401 may be rotated using the handle 411 around the longitudinal axis 409 of the surgical rod 407 to shape the end of the surgical rod 407.

In one embodiment, the shaping assembly 401 may include a spindle that is coupled to a motor suitable for rotating the head assembly 403 relative to the longitudinal axis 409 of the surgical rod 407 and thus conducting the shaping process automatically. In another embodiment, the tool 400 can include a spindle configured to engage the surgical rod and rotate the surgical rod 407 relative to the shaping head 403 of the shaping assembly 401 and thus conducting the shaping operation automatically. In still certain other embodiments, the tool 400 can include multiple spindle configurations, such that the shaping assembly 401, and particularly the head assembly 403, is connected to a spindle that is connected to a motor for rotation of the head assembly 403 and the shaping surface 404. The rod 407 can be inserted and coupled to a second spindle that is also connected to a motor for rotation of the rod 407.

In accordance with another embodiment, the shaping assembly 401 includes a slide assembly for translating the rod 407. The slide assembly can facilitate translation of the rod 407 in multiple directions for suitable positioning of the rod relative to the shaping assembly 401 as well as movement of the rod 407 between the shaping assembly 401 and the finishing assembly 430 without having to release the rod from a vise or other holding mechanism between assemblies. As such, in one embodiment, the slide assembly is capable of translating the rod 407 in a direction parallel to the longitudinal axis 409 of the surgical rod 407 for engagement and disengagement with the shaping assembly 401. The slide assembly can include translational capabilities in multiple directions such as a lateral direction, perpendicular to the longitudinal axis 409 of the surgical rod 407 for positioning of the rod with the shaping assembly 401 and movement between the shaping assembly 401 and finishing assembly 430. Additionally, the shaping assembly 401 may include altitude adjustment, such that the rod 407 can be placed at a suitable height above the major planar surface 402 for engagement with the shaping assembly 401.

The shaping assembly 401 can include an angulation assembly suitable for changing the angle of the surgical rod 407 relative to the major planar surface 402 of the tool and relative to a longitudinal axis of the opening 406 within the shaping head 403 for proper orientation of the rod 407. Additionally, angulation capabilities facilitate greater flexibility in the desired shape of the rod end since it may be angled relative to the shaping surface 404 within the shaping head 403, allowing slight modifications to the shaped rod end, such as a shape offset from the center of the rod 407.

As noted previously, the shaping head 403 can be selected from a plurality of interchangeable shaping heads, wherein each of the shaping heads have different shaping surfaces 404 configured to impart different contours to the end of the surgical rod 407. Accordingly, the shaping head 403 may be releasably engageable with the shaping assembly 401, and particularly with the handle 411 for quick releasing and coupling between interchangeable shaping heads.

In addition to the components of the shaping assembly 401 illustrated in FIG. 4, components not illustrated may be incorporated to facilitate the shaping process. For example, in one embodiment, the shaping assembly 401 can include a heater connected to and disposed within the interior of the shaping head 403 in a position configured to heat the end of the surgical rod 407 during a shaping process. The heater can include an induction heater or heating surface designed to provide thermal energy to the end of the rod via radiation, convection or conduction.

Additionally, the shaping assembly 401 can include a fluid reservoir connected to and extending through the shaping housing to deliver fluid to the shaping head 403, and particularly to the shaping surface 404 to facilitate the shaping process. Delivery of a fluid to the shaping surface 404 may facilitate cooling of the end of the rod, swarf removal, and cleaning of the end of the rod during the shaping process. In addition, as described herein, the fluid reservoir may also be suitable for delivering chemicals, such as an etchant, for situations in which the shaping operation includes a chemical etchant.

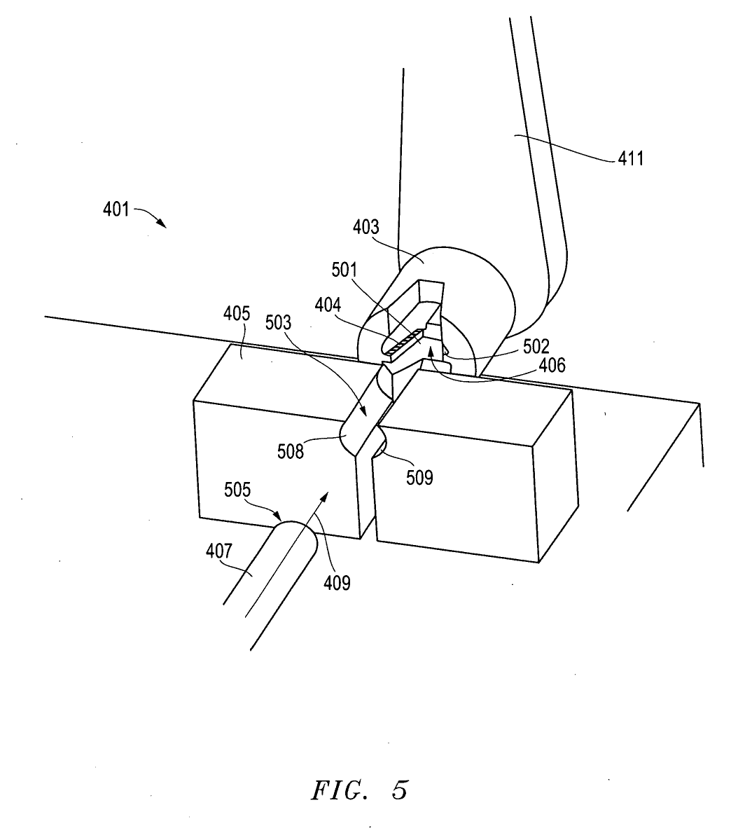

Referring briefly to FIG. 5, a perspective view of a portion of a shaping assembly is illustrated in accordance with an embodiment. In particular, the shaping assembly 401 includes a shaping head 403 having an opening 406 extending longitudinally into the body of the shaping head 403. The shaping head 403 also includes a shaping surface 404 disposed in the opening 406 of the shaping head 403 and configured to remove material from the end of the surgical rod 407 thus shaping the end of the surgical rod 407. The vise 405 is intended to hold the surgical rod 407 relative to the shaping head 403. The handle 411 allows for user-enabled rotation of the shaping head 403 around the longitudinal axis 409 of the surgical rod 407 such that upon engagement of the surgical rod 407 within the opening 406 the shaping surfaces 404 cut or remove portions of the end of the surgical rod 407 imparting the desired shape.

As illustrated in the embodiment of FIG. 5, the contours of the shaping surface 404 are more clearly illustrated. In particular, the shaping surface 404 includes cutting surfaces designed to remove material from the end of the rod 407 upon rotation of the shaping head 403. The shaping surface 404 includes surfaces 501 and 502 angled relative to the longitudinal axis 409 of the surgical rod 407 such that upon rotation about the longitudinal axis 409 of the rod 407, the shaping surfaces 501 and 502 engage the corners 505 of the rod end and remove these portions of the rod to shape the rod end. According to the illustrated embodiment, the cutting surfaces 501 and 502 of the shaping head 403 are oriented to form a rod end having a conical or frustoconical contour.

In particular, the shaping surfaces 501 and 502 can have interchangeable cutting inserts for maintaining sharp surfaces for efficient and accurate shaping. Moreover, different cutting inserts can be used based on the material of the rod. For example, in the case of very hard rod materials, such as stainless steel, it is suitable to use a cutting insert of a material as hard, or more preferably harder than the material of the rod. As such, the cutting inserts can include a metal material, ceramic material, or combination thereof. Suitable ceramic materials can include oxides, borides, nitrides, carbides, other carbon-containing materials such as diamond, or a combination thereof. Some suitable metal materials for use in the sharpened cutting surfaces can include titanium, tantalum, tungsten, vanadium, chrome, cobalt, iron and any combination thereof.

The vise 405 includes an opening 503 defined by a surfaces 508 and 509 having a substantially semi-circular contours when viewed in cross-section. The opening 503 can be sized such that it has a contour properly suited to complement the curvature of the rod 407. In particular instances where the rod 407 is rotated about the longitudinal axis 409, the opening 503 can be configured to support the rod 407 without interfering with the rotary motion of the rod 407. As such, the surfaces 508 and 509 may be made of a lubricious material, or even have a coating containing a lubricious material, to allow rotation of the rod 407 without excessive frictional resistance. Some suitable lubricious materials can include liquid or solids lubricants. For example, solid lubricant materials can include ceramic materials like graphite, or alternatively, a polymer material such as PTFE. In other embodiments, the surfaces 508 and 509 can be coated by the user with a lubricant, or in alternative embodiments can be manufactured to include such a coating incorporating a lubricious material.

While embodiments herein have illustrated a shaping assembly 401 configured to cut or remove portions of material from the end of the surgical rod 407, it will be appreciated that the shaping assembly can alternatively include swedging, pressing, and molding the end of the surgical rod 407. In such embodiments, the configuration of the handle 411 and head assembly 403 for example, the handle can be actuated linearly in a direction by user to actuate shaping surfaces which are configured to swedge, press, or mold the end of the surgical rod 407.

Referring again to FIG. 4, the finishing assembly 430 is attached to the major planar surface 402 of the table-top tool 400. In accordance with a particular embodiment, the finishing assembly 430 includes a finishing housing 431 including a finishing insert 433 contained therein. As illustrated, the finishing insert 433 is configured to releasably engage with the finishing housing 431 and includes a plurality of finishing teeth 435 extending into an interior of an opening of the finishing insert 433 and having finishing surfaces configured to selectively remove portions of the end of the surgical rod 407 to reshape the surgical rod into the finished rod end. In accordance with a more particular embodiment, the finishing assembly 430 is constructed such that the finishing insert 433 is one of a plurality of interchangeable inserts configured to be engaged within the finishing housing 431. In particular, each of the finishing inserts are configured to have different finishing surfaces, such that a variety of contours can be formed at the end of the surgical rod 407 depending upon the selected finishing insert 433.

As particularly illustrated in FIG. 4, the finishing assembly 430 can be a broaching assembly. The broaching assembly is designed to be translated in a direction perpendicular to the longitudinal axis 409 of the surgical rod 407 thereby engaging the plurality of broaching teeth along the end of the surgical rod 407. In accordance with the broaching process, each of the broaching teeth are positioned within the broaching assembly, such that upon passage of each of the rows of teeth over the rod end, a small portion of material from the rod end is removed such that it is reshaped into a finished rod end.

While FIG. 4 illustrates a finishing assembly 430, and particularly a broaching assembly, configured to be translated in a vertical direction, other broaching assemblies are possible. For example, a broaching assembly translating in a horizontal direction. Or alternatively, a rotary broaching assembly wherein the insert 433 or alternatively the entire finishing assembly 430 is rotated with the rod 407 in a manner to remove material from the end of the rod 407 and shape the finished rod end.

In accordance with one embodiment, the finishing assembly 430 can be actuated by a ratcheting assembly 443. In particular, the ratcheting assembly 443 includes a handle 445 which when rotated, rotates a tooth portion 441 configured to engage a complementary geared surface 439 translating the finishing housing 431 in a linear direction through the opening 447 in the major planar surface 402 of the tool 400. As such, the ratcheting assembly 443 illustrated is a rack and pinion assembly for changing rotary motion of the handle 445 to linear motion of the finishing housing 431. As the finishing housing 431 is translated in a direction through the opening 447, the plurality of finishing teeth 445 are engaged with and remove portions of the rod end thus giving the rod end its finished shape. It will be appreciated that while FIG. 4 illustrates a finishing assembly 430 that is manually operated, other configurations can be contemplated making the finishing assembly an automated process. In particular, the rotatable tooth portion 441 may be connected to a motor that is operates a spindle or drive shaft to turn the tooth portion 441 and drives the finishing housing 431. Additionally, other arrangements of a ratcheting mechanism can be used to avoid back-tracking of the finishing assembly relative to the rod end.

In accordance with a particular embodiment, the finishing teeth 435 can include cutting surfaces made of metal material, ceramic material, or a combination thereof. Suitable metal and ceramic materials include those described in accordance with cutting surfaces of other embodiments. In particular, the finishing teeth 435 can include interchangeable cutting inserts such as those described herein. As such, the interchangeable cutting inserts can be selected based upon the material of the rod being shaped such that the cutting inserts are suitable for cutting the material of the rod.

In alternative embodiments, the finishing assembly 430 can include other components to carry out other processes, such as a pressing assembly to shape the rod 407. Such pressing assemblies can be utilized to form grooves, indentations, or other surface features at the end of the rod 407. As will also be appreciated, the finishing assembly 430 may further include a heater for heating the end of the rod for easier shaping, particularly for use with processes such as molding, swedging, and pressing. According to one embodiment, one or more of such processes can be carried out in combination with the broaching process.

The finishing assembly 430 can include a liquid reservoir suitable for carrying and disposing water at the end of the rod during the finishing process. In addition to water, other liquid agents may be disposed at the end of the rod via the liquid reservoir, including for example, cleaning agents, sterilizing agents, and chemicals.

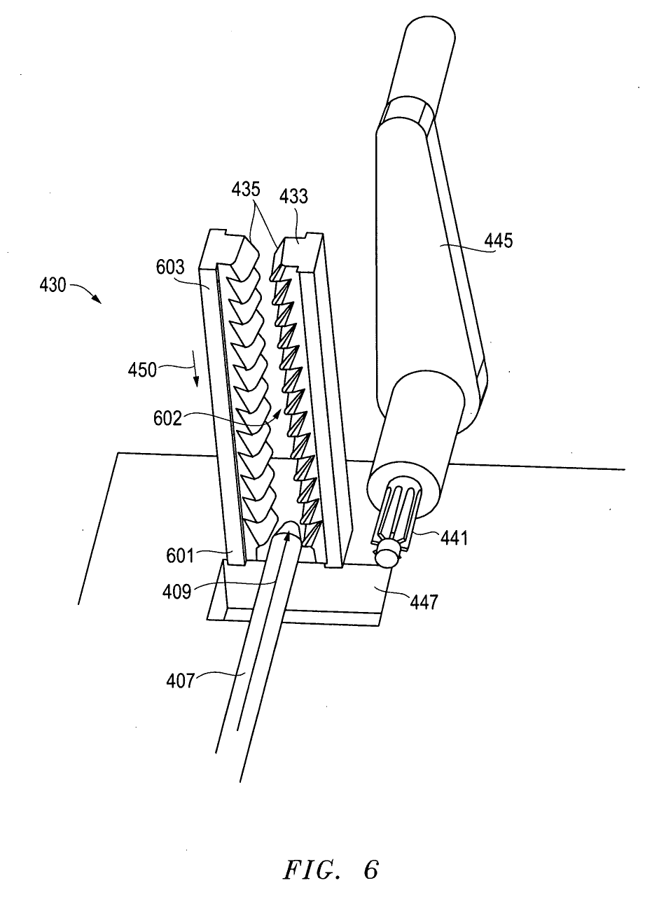

FIG. 6 includes a perspective view of the finishing assembly, and more particularly, a broaching assembly. In particular, FIG. 6 more clearly illustrates the finishing teeth 435 of the finishing insert 433. Accordingly, as the tooth portion 441 is rotated with respect to the geared surface (not illustrated) of the finishing housing (not illustrated) the finishing insert 433 is translated in a direction 450 through the opening 447 such that each of the rows of finishing teeth 435 engage and remove a portion of the end of the surgical rod 407.

As more clearly illustrated in FIG. 6, the plurality of finishing teeth 435 extend into the opening 602 of the finishing insert 433. In particular, the rows of finishing teeth 435 at the distal end 601 of the finishing insert 433 are spaced further apart in the opening 602 than the rows of finishing teeth 435 at the proximal end 603 of the broaching insert 433. Given this design, when the broaching insert is translated in the direction 450, each subsequent row of finishing teeth 435 are configured to engage and remove a small, discrete amount of material such that upon full translation of the finishing insert 433 in direction 450, the end of the rod 407 is reshaped, having a significantly different contour than prior to the finishing process. It will be appreciated that a broaching process facilitates the formation of more complex shapes than certain other finishing processes.

In accordance with a particular embodiment, the broaching process is used as a finishing process to form a trocar-shaped end of the surgical rod, which is a particularly useful shape for coupling with certain implants and a shape suitable for easy percutaneous insertion. Moreover, the broaching process is particularly suitable for use with a broad range of rod materials, and is particularly suited for finishing the end of polymer rods, such as those comprising PEEK.

According to another embodiment, the tool 400 can include a cutting assembly (not illustrated) at the major planar surface 402 and combined with the shaping assembly and the finishing assembly. The cutting assembly can be used to cut the rod to length before the shaping and finishing processes are undertaken. As such, the tool 400 can provide a single tool capable of cutting and finishing a rod. The cutting assembly can include a standard table-top cutter comprising an actuating arm configured to operate a blade which is designed to sever a surgical rod.

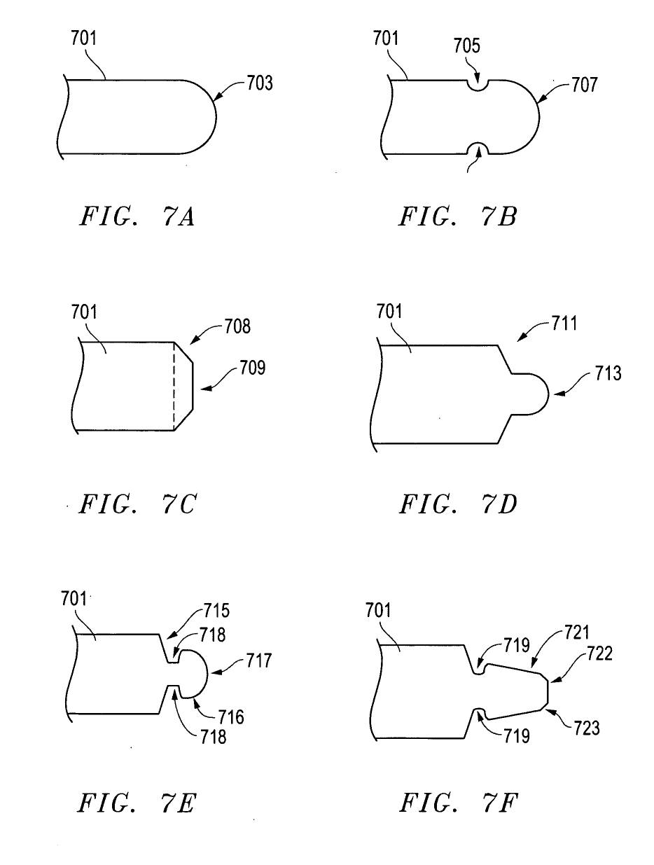

FIGS. 7A through 7F provide cross-sectional illustrations of various possible shaped ends based upon the tools and methods described herein. In particular, FIG. 7A illustrates a rod end 701 having an end contour 703 that is rounded or semi-hemispherical. Such an end contour 703 may be formed by any of the processes and assemblies described herein.

FIG. 7B illustrates a rod end 701 having a generally semi-hemispherical or rounded end contour 707. In addition, the rod end 701 further includes grooves 705 which are formed in the rod end 701 and displaced a distance from the terminal end of the rod. The grooves 705 can extend laterally, that is substantially perpendicular to the longitudinal axis 409 of the rod end, and can have a generally linear shape without extending around the circular cross-sectional circumference of the rod end 701. In an alternative embodiment, the grooves 705 can extend around a greater portion or the entire circular cross-sectional circumference of the rod end 701. The grooves 705 can provide suitable coupling surfaces for engagement of the rod end and another implant. Moreover, in certain embodiments, the inner surfaces of the grooves 705 can be etched, such that they have texture to aid coupling with another implanted component.

FIG. 7C illustrates a rod end 701 having a beveled or chamfered surface 708 proximate to the terminal surface 709 of the rod end 701. The beveled or chamfered surface 708 can extend around the entire circular cross-sectional circumference of the rod end 701, or alternatively may be formed along discrete portions of the circular cross-sectional circumference of the rod end 701. In certain embodiments, the beveled surface 708 may be linear shaped, that is not curved with the contour of the rod, but rather forming a polygonal shape, such as a trapezoid at the rod end 701.

FIG. 7D illustrates a rod end 701 having a beveled surface 711 proximate to a terminal end 713 wherein the terminal end 713 comprises a rounded contour. In particular, the beveled surface 711 is abutting the semi-hemispherical or rounded end terminal end 713. The combination of the beveled surface 711 and the narrowed, curved terminal end 713 may be particularly suitable for rods designed for percutaneous delivery and reduced tissue irritation.

FIG. 7E illustrates another embodiment of a rod end 701 formed according to processes and assemblies herein. The rod end 701 includes beveled surfaces 715 and 716 that form a groove 718 extending around the circular cross-sectional circumference of the rod end 701. The rod end 701 further includes a terminal end 717 having a rounded contour and a flat surface 716 extending around the circular cross-sectional circumference of the terminal end 717 disposed between the groove 718 and the terminal end 717. While, the embodiment illustrates a flat surface 716, certain other embodiments may remove the flat surface 716 such that the terminal end includes a semi-spherical terminal end. Such a finished rod end may be particularly suitable for coupling with other implants via the grooves 715. to the longitudinal axis of the rod 701. The groove 718 and beveled surfaces 715 and 716 may be textured to enhance coupling.

FIG. 7F illustrates another embodiment of a rod end 701 formed according to processes and assemblies herein. In particular, the rod end 701 includes a trocar-shaped end including a semi-conical portion 721 disposed at the terminal end between a grooves 719 that extend linearly in a direction substantially perpendicular to the longitudinal axis 409 of the rod end 701. The trocar-shaped end of the rod 701 further includes a beveled surface 723 proximate to and abutting the terminal end 722 that has a planar contour. Such a design as illustrated in FIG. 7F as particularly suitable for percutaneous delivery of the rod as well as coupling of the rod end with an implanted device. According to one particular embodiment, formation of the trocar-shaped rod end, can be formed using first a shaping process of cutting in which a semi-conical shape is roughly formed in the rod end 701, followed by a finishing process using broaching to precisely cut the grooves 719, semi-conical portion 721, and beveled surface 723.

It will appreciated that while the disclosure herein makes references to rods, and the rods illustrated herein have been monolithic members, the process of shaping and finishing ends of rods can be completed on various types of rods. For example, in certain embodiments, the rods may not necessarily have circular cross-sectional contours, and instead can have other polygonal cross-sectional shapes, like elliptical or oval cross-sectional shapes. Some rods may have irregularly-shaped cross-sectional contours. Moreover, it will be appreciated that shaping and finishing of the many different rod shapes can be completed using the same tool as described in accordance with embodiments herein.

Additionally, it will be appreciated that the rods herein may not necessarily be straight members. In fact, in certain procedures it is suitable to use a rod that is curved or bent to urge the portion of the spine into a new position. The rods can be bent before or after the shaping and finishing of the end of the rod without obscuring the shaping and finishing processes depending upon the surgeon's preference.

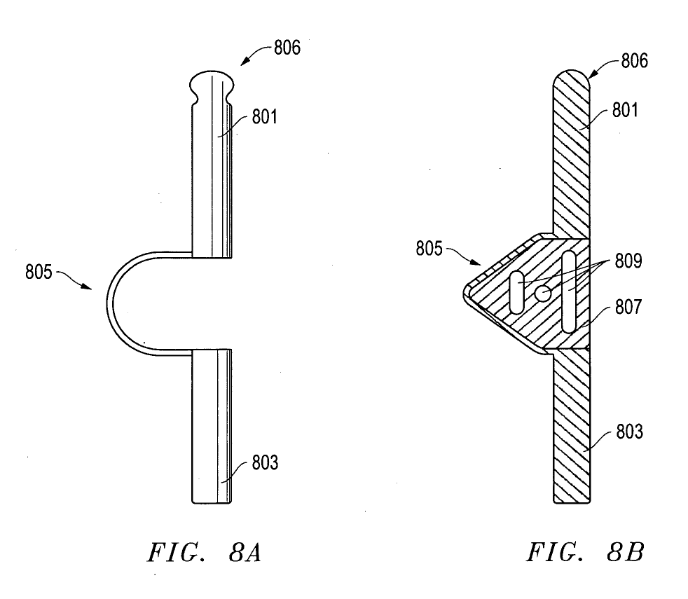

Turning to FIGS. 8A and 8B, two alternative rod types are illustrated according to embodiments herein. Notably, FIGS. 8A and 8B illustrate vertebral rods having different sections for dynamic stabilization of portions of the spine. FIG. 8A includes a rod having an upper section 801, a lower section 803, and an intermediate section 805 disposed between upper and lower sections 20 and 30. The intermediate section 805 can have a different shape or be made of a different material suitable for absorbing forces upon the rod in multiple directions such that the rod provides dynamic stabilization for a portion of the spine. Notably, the rod end 806 is shaped according to embodiments herein, such that it is suitable for percutaneous delivery and reduced tissue irritation based on its contour.

FIG. 8B provides an alternative rod for dynamic stabilization according to another embodiment. The rod includes an upper section 801, a lower section 803, and an intermediate section 805 disposed between upper and lower sections 20 and 30. The intermediate section 805 has a partially polygonal shape, including two sides angled relative to each other and an elastic member 807 disposed within the intermediate section 805 such that the rod is suitable for absorbing shocks. The elastic member 807 further includes openings 809 extending entirely through the body of the elastic member 807 to control the elastic properties of the elastic member 807. Notably, the end 806 of the rod is shaped such that it has a contour different than the opposite end. The shape of the end 806 is curved such that it is suitable for placement without excess tissue irritation and easy percutaneous delivery.

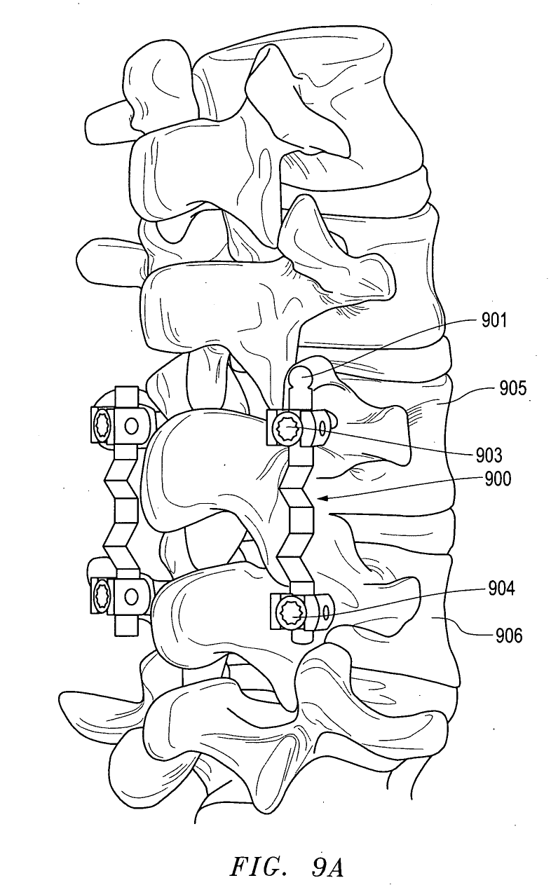

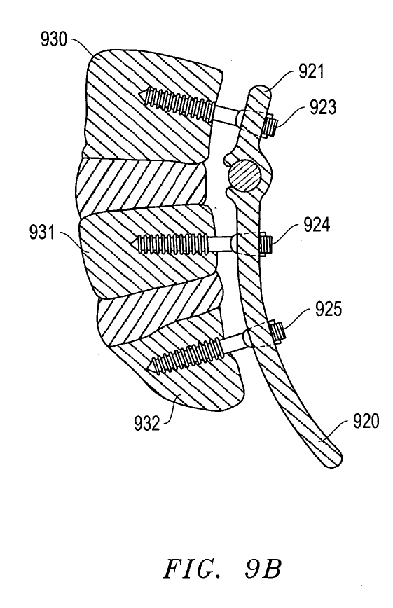

FIGS. 9A and 9B provide views of rod and anchor systems connected to portions of a spine for a fuller understanding of certain types of orientations and uses for the rods. As illustrated in FIG. 9A, a rod 900 having dynamic stabilization capabilities is inserted within the heads of screws 903 and 904 that are anchored within vertebra 905 and 906, respectively. The extension of the rod 900 between the anchors, which in turn are connected to the vertebra 905 and 906, facilitates dynamic stabilization of the spine across the vertebra 905 and 906. As further illustrated in FIG. 9A, the end 901 of the rod 900 is formed to have a rounded shape in accordance with embodiments herein. As illustrate, in some instances, it may be useful to have more than one rod and anchor system spanning the affected portion of the spine for additional support.

FIG. 9B includes a cross-sectional side view of a portion of a spine incorporating a rod and anchor system, wherein the end of the rod is shaped and finished according to embodiments herein. The rod 920 is attached to the anchors 923, 924, and 925 (923-925), and particularly attached through head portions of the anchors 923-925 such that it is coupled to and spanning the vertebra 930, 931, and 932 in which the anchors 923-925 are attached. The rod end 921 has been shaped and finished such that it has a generally conical contour. Such a contour aids insertion into the patient, through the heads of the screws 923-925 and also reduces the surface area and sharp corners for reduced tissue irritation.

The foregoing has described methods and apparatuses suitable for forming finished rod ends. In particular, the processes and apparatuses herein include a combination of components suitable for shaping and finishing surgical rods such that the rods are suitable for implantation in patients without excessive tissue irritation or damage, facilitate percutaneous delivery, and rod ends suitable for coupling with other implantable components. All such features are provided in a compact table-top tool suitable for use in an operatory and including components, that are capable of being sterilized. While shaping of rod and tube ends to remove burrs and provide chamfered surfaces is known (see, for example, U.S. Pat. No. 5,465,471, U.S. Pat. No. 5,623,858, or U.S. Pat. No. 5,564,871), such tools have not combined the features disclosed herein. Certain of those features including, a shaping assembly comprising interchangeable shaping heads having a plurality of shaping surfaces, finishing assemblies including broaching capabilities, cutting assemblies, deburring assemblies, and etching and cleaning assemblies.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus for finishing an end of a rod comprising:
a shaping tool comprising:
a shaping assembly including a shaping housing and a shaping surface within the housing configured to engage an end of a rod and form a shaped rod end; and
a finishing tool comprising:
a finishing assembly including a finishing surface for changing the contour of the shaped rod end to form a finished rod end.

2. The apparatus of claim 1, wherein the shaping housing comprises an opening extending along a longitudinal axis of the shaping housing, the opening configured to receive the end of the rod.

3. The apparatus of claim 1, wherein the shaping housing is rotateable about a longitudinal axis of the shaping housing.

4. The apparatus of claim 1, wherein the shaping surface comprises a cutting surface for removing material from the end of the rod.

5. The apparatus of claim 1, wherein the shaping surface comprises an abrasive surface for removing material from the end of the rod.

6. The apparatus of claim 1, wherein the shaping assembly comprises a plurality of interchangeable shaping heads, and wherein each of the shaping heads of the plurality of interchangeable shaping heads comprise a different shaping surface.

7. The apparatus of claim 1, wherein the shaping assembly includes a heater within the shaping housing for heating the end of the rod.

8. The apparatus of claim 1, wherein the shaping surface comprises a die press surface for pressing the end of the rod.

9. The apparatus of claim 1, wherein the shaping surface comprises a molding surface for molding the end of the rod.

10. The apparatus of claim 1, wherein the finishing assembly comprises a finishing housing and an insert configured to releasably engage within the finishing housing.

11. The apparatus of claim 10, wherein the insert of the finishing assembly comprises a broaching assembly.

12. The apparatus of claim 11, wherein the broaching assembly comprises a ratcheting mechanism for ratcheted translation of the broaching assembly.

13. An apparatus for finishing an end of a rod comprising:
a cutting tool comprising:
a cutting assembly configured to sever a rod;
a shaping tool comprising:
a shaping assembly including a housing and a shaping surface within the housing, wherein the shaping surface is configured to remove material from an end of the rod and form a shaped rod end; and
a finishing tool comprising:
a finishing assembly including a broaching assembly for changing a contour of the shaped rod end to form a finished rod end.

14. The apparatus of claim 13, wherein the cutting tool, shaping tool, and finishing tool are contained at a same table-top unit.

15. A method of finishing an end of a surgical rod comprising:
cutting a surgical rod to be implanted to form a surgical rod having a cut rod end;
shaping the cut rod end by changing the contour of the cut rod end and forming a shaped rod end; and
finishing the surgical rod by changing the contour of the shaped rod end to form a finished rod end.

16. The method of claim 15, wherein the surgical rod comprises a polymer material.

17. The method of claim 16, wherein the surgical rod comprises a polymer material including a reinforcing material.

18. The method of claim 15, wherein shaping comprises removing material from the cut rod end using a process selected from the group of processes consisting of abrading, cutting, swedging, pressing, etching, molding, and heating.

19. The method of claim 15, wherein shaping comprises:
heating the cut rod end of the surgical rod, wherein the surgical rod comprises a polymer material; and
molding the cut rod end using a molding surface to form a shaped rod end.

20. The method of claim 15, wherein the finishing comprises changing the contour of the shaped rod end using a broaching assembly, the broaching assembly comprising a plurality of broaching teeth for removing portions of the shaped rod end.
